(19) United States
(12) Patent Application Publication
(10) Pub. No.: US 2019/0247682 A1
(43) Pub. Date: Aug. 15, 2019

(54) PERSONAL BREATHING APPARATUS AND METHOD

(71) Applicant: Spencer Sutherland, Spring Creek, NV (US)

(72) Inventor: Spencer Sutherland, Spring Creek, NV (US)

(21) Appl. No.: 16/276,390

(22) Filed: Feb. 14, 2019

Related U.S. Application Data
(60) Provisional application No. 62/631,202, filed on Feb. 15, 2018.

(51) Int. Cl. A62B 9/06; A41D 13/11; A62B 7/10; A62B 9/02

(52) U.S. Cl. CPC A62B 9/06; A41D 13/1107; A62B 23/025; A62B 9/02; A62B 7/10

(57) ABSTRACT

A personal breathing apparatus; the personal breathing apparatus includes a body having an exhaust port, a nasal-port, at least one filter-port, and a mouth-port. A nasal insert is configured to attach to the nasal-port. A mouthguard is anatomically shaped to create an air-tight seal to a user's mouth. The mouthguard is configured to attach to the mouth-port. The filter-port is designed to attach to at least one filter. At least one filter is included with the personal breathing apparatus. By design, the personal breathing apparatus is lightweight and unobtrusive. The personal breathing apparatus does not rely on an airtight seal between the apparatus and a large portion of the surface area of the users face.

### CROSS-REFERENCE TO RELATED APPLICATION(S)

The present application is related to and claims priority to U.S. Provisional Patent Application No. 62/631,202 filed Feb. 15, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of filtered face masks of existing art and more specifically relates to personal breathing masks.

### RELATED ART

Personal breathing devices such as respirators are used in many industries. Government regulations have for many years required the use of respirators. Contaminants in the air have been studied and standards for particulates in the air of a workplace environment have been set. For a worker to function in a healthy environment, the use of a respirator is required. The style of respirator used in the work environment is bulky, restrictive, and only used when absolutely necessary. Furthermore, the commonly used conventional respirator is heavy, requires a shaven face, and limits visibility.

U.S. Pat. No. 7,025,060 to Alexander J. G. Nicholson relates to a personal breathing filter. The described personal breathing filter includes a personal air filtration device that has a cylindrical exhalation tube, with a one-way valve thereon. Concentric around the periphery of the exhalation tube and integrally connected to the exhalation tube rearward (proximate the user's mouth) of the one-way valve is a filter media housing. Filter media is contained between the housing and the tube. A plurality of perforations in the exhalation tube, rearward of the one way valve but forward from the housing connection ring, provide inhaled air ingress to the exhalation tube. Inhaled air forces the one-way valve closed, so that air is directed through the filter media, passes through the perforations and into the exhalation tube where the user can take in the cleansed air. The pressure of the exhaled air through the exhalation tube causes the one-way valve to open, so that exertion by the user is minimized.

### SUMMARY OF THE INVENTION

In view of the foregoing disadvantages inherent in the known personal breathing mask art, the present disclosure provides a novel personal breathing apparatus and method. The general purpose of the present disclosure, which will be described subsequently in greater detail, is to provide an effective and efficient personal breathing apparatus and method.

A personal breathing apparatus is disclosed herein. The personal breathing apparatus includes a body having an exhaust port, a nasal-port, at least one filter-port, and a mouth-port. A nasal insert is configured to attach to the nasal-port. The nasal insert may be used to allow a user to breath filtered air through. An anatomically shaped mouthguard is included and designed to create an air-tight seal to a user's mouth. The mouthguard is configured to attach to the mouth-port and secure the personal breathing apparatus to the face of a user. The mouthguard includes a breathing-channel configured for the passage of breathable air. At least one filter is included and is configured to attach to the at least one filter-port. The personal breathing apparatus further includes at least one one-way valve that is in communication with the nasal-port, the filter-port, and the mouth-port.

According to another embodiment, a method of using a personal breathing apparatus is also disclosed herein. The method of using a personal breathing apparatus includes providing a personal breathing apparatus as described above; a step of, inserting the mouthguard into the mouth-port of the body; a next step of, inserting the nasal insert into the nasal-port of the body; a step of, attaching at least one filter to the at least one filter-port of the body; and lastly a step of, breathing through the mouthguard and the nasal insert. Further optional step(s) may include cleaning the mouthguard, the nasal insert, and the body.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a personal breathing apparatus and method, constructed and operative according to the teachings of the present disclosure.

FIG. 1 is a front perspective view of the personal breathing apparatus during an ‘in-use’ condition, according to an embodiment of the disclosure.

FIG. 2 is a front perspective view of the personal breathing apparatus of FIG. 1, according to an embodiment of the present disclosure.

FIG. 3 is a rear perspective view of the personal breathing apparatus of FIG. 1, according to an embodiment of the present disclosure.

FIG. 4 is a component view of the personal breathing apparatus of FIG. 1, according to an embodiment of the present disclosure.

FIG. 5 is a flow diagram illustrating a method of using a personal breathing apparatus, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to breathing apparatuses and more particularly to a personal breathing apparatus and method as used to improve the efficient and effective use of breathing apparatus.

Generally, the personal breathing apparatus is a light weight, minimalistic body having multiple attachment points. The apparatus replaces a conventional face-mask style respirator. The body includes attachment points for air filters. The air filter attachment points are designed such that standardized air filters can be attached. By design, a user can attach and replace any portable air filter with ease with full functionality. The body further includes attachment points for a users' mouth and nose. In a preferred embodiment a mouthguard is included with the personal breathing apparatus. The mouthguard is configured to be secured to an attachment point on the body. The mouthguard includes a breathing channel that allows the passage of breathable air. When attached, the mouthguard is designed to be inserted into a users' mouth to hold the personal breathing apparatus in place. The mouthguard is in communication with a valve that allows only filtered air into a users' lungs. A nose insert is included with the personal breathing apparatus. The nose insert is configured to be secured to another attachment point on the body. The nose insert is configured to attach to a users' nose. The nose insert includes various styles, including a style that also permits the passage of breathable air. Another style of the nose insert prohibits the passage of breathable air by plugging the nose. Yet another style of the nose insert is configured to clamp a users' nasal passages shut. All styles (embodiments) of nose inserts are configured to provide a support point to keep the personal breathing apparatus attached to a users' face.

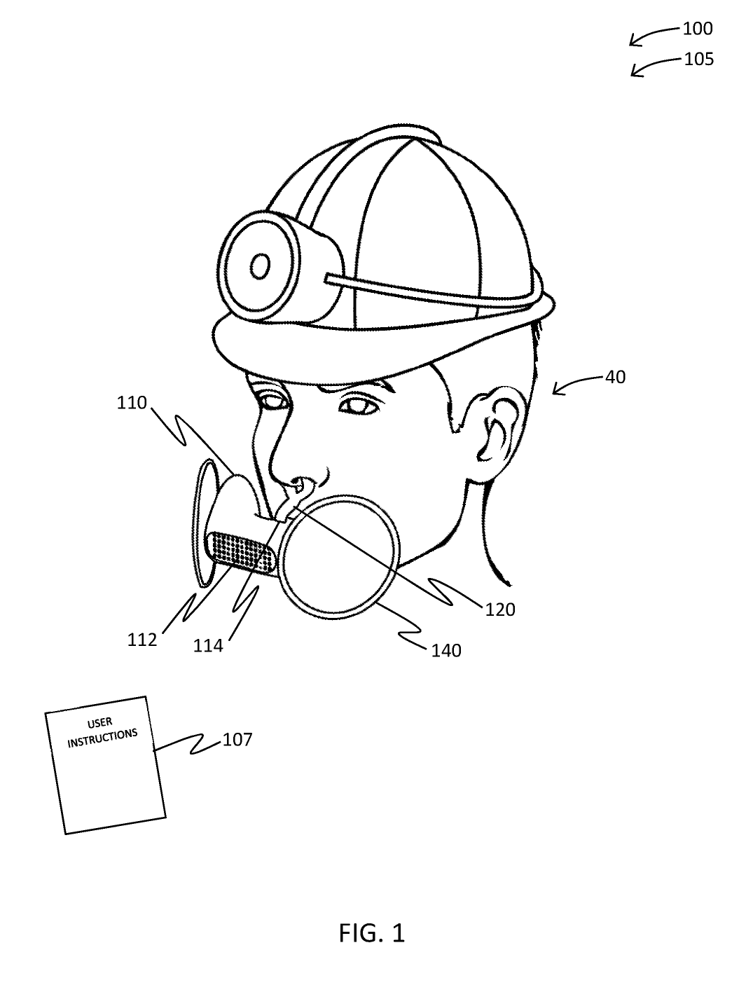

Referring now more specifically to the drawings by numerals of reference, there is shown in FIGS. 1-4, various views of a personal breathing apparatus 100.

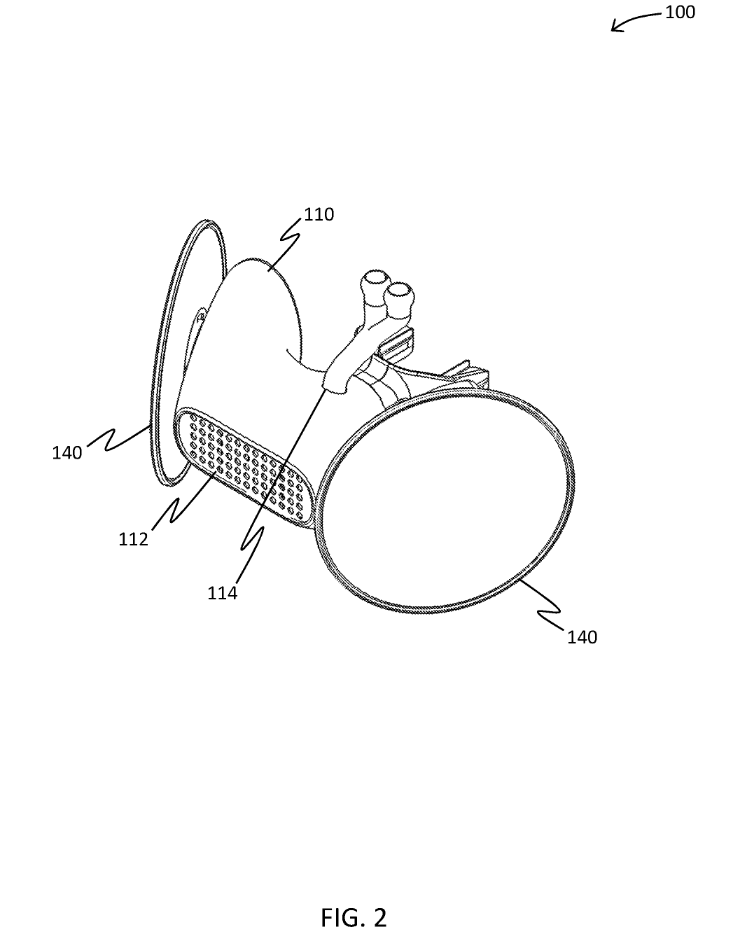

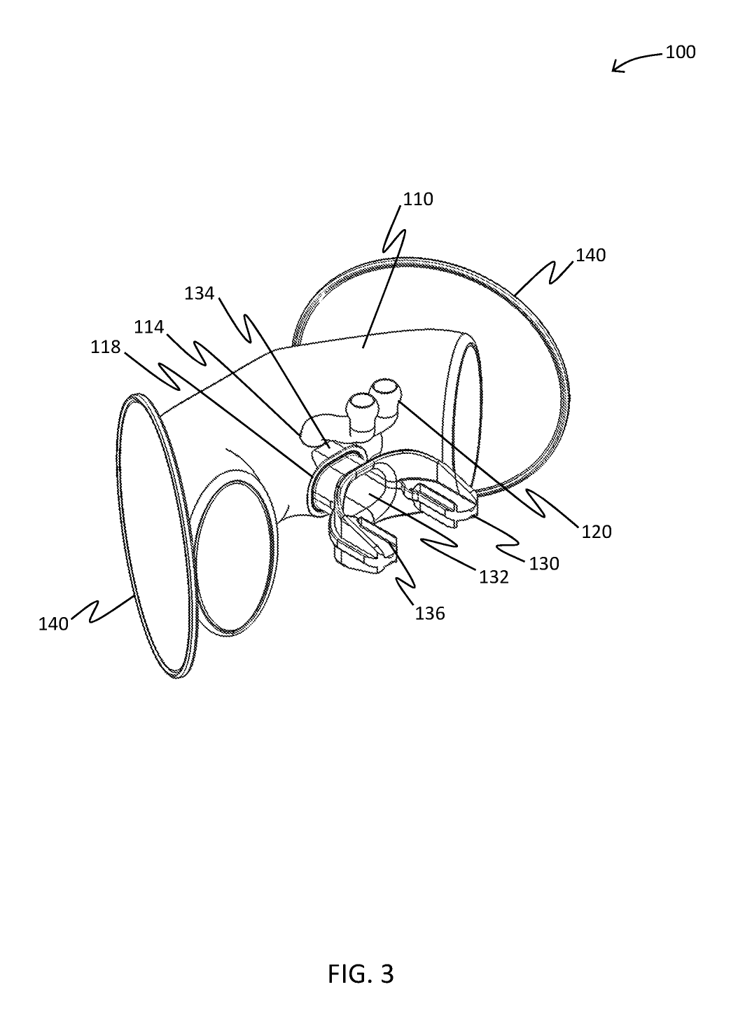

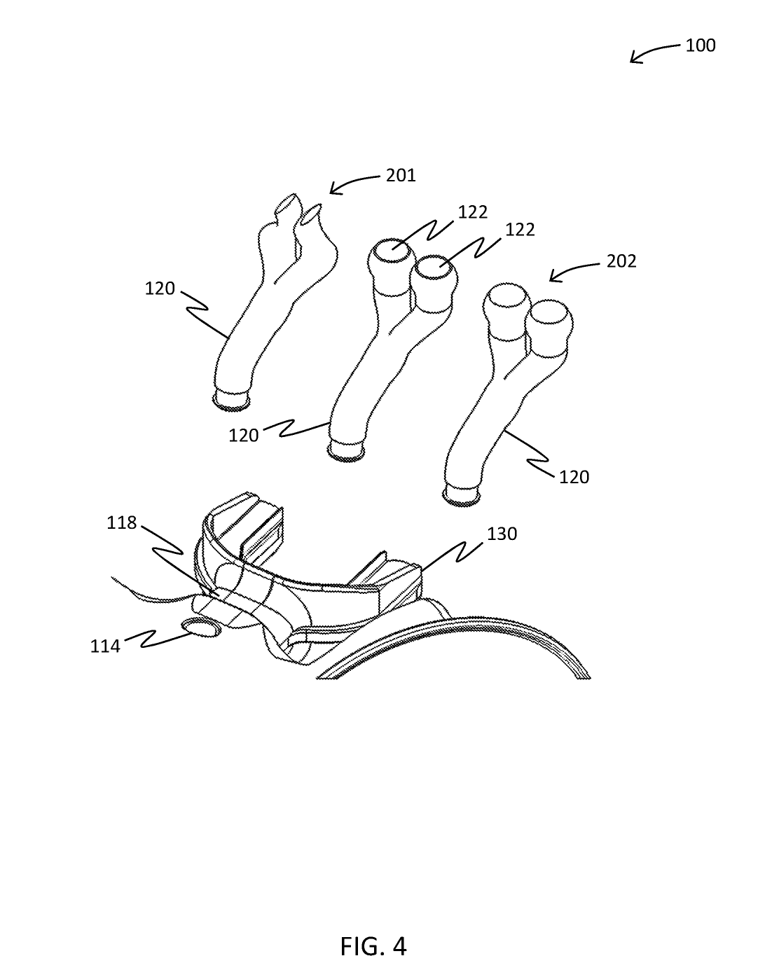

FIG. 1 shows a personal breathing apparatus during an ‘in-use’ condition 50, according to an embodiment of the present disclosure. Here, the personal breathing apparatus may be beneficial for use by a user 40 to filter air. As illustrated, the personal breathing apparatus 100 may include a body 110 having an exhaust port 112, a nasal-port 114, at least one filter-port (not shown), and a mouth-port 118. A nasal insert 120 is configured to attach to the nasal-port 114. The nasal insert 120 is designed for interaction with the nose of a user 40. The nasal insert 120 may have many embodiments as illustrated in FIG. 4. Shown in FIG. 2, the mouthguard 130 is anatomically shaped to create an air-tight seal to a user's mouth. The mouthguard 130 may comprise rubber or another easily malleable, non-toxic material. The mouthguard 130 (FIG. 2) is configured to attach to the mouth-port 118 (FIG. 3). The mouthguard 130 (FIG. 2) preferably includes a breathing-channel 132 (FIG. 3) that allows the passage of breathable air therethrough. At least one filter 140 is configured to attach to the at least one filter-port (not shown). The exhaust port 112, nasal-port 114, the at least one filter-port (not shown), and the mouth-port 118 may be aligned with at least one one-way valve (not shown). The at least one one-way valve (not shown) is configured to be removably replaceable from said body 110. The at least one one-way valve (not shown) 150 may be removed for easy cleaning and maintenance. The at least one one-way valve (not shown) 150 is selected from a group consisting of butterfly valves, flap vales, ball bearing valves, and check valves. Further valve technologies may also be considered.

According to one embodiment, the personal breathing apparatus 100 may be arranged as a kit 105. In particular, the personal breathing apparatus 100 may further include a set of instructions 107. The instructions 107 may detail functional relationships in relation to the structure of the personal breathing apparatus 100 such that the personal breathing apparatus 100 can be used, maintained, or the like, in a preferred manner.

FIG. 2 shows the personal breathing apparatus 100 of FIG. 1, according to an embodiment of the present disclosure. As above, the personal breathing apparatus 100 may include a body 110 having an exhaust port 112, a nasal-port 114, at least one filter-port (not shown), and a mouth-port 118 (FIG. 3). Nasal insert(s) 120 is/are configured to attach to the nasal-port 114. A mouthguard 130 is included and used to retain the personal breathing apparatus 100 to a user's face. The mouthguard 130 is anatomically shaped to create an air-tight seal to a user's mouth. The mouthguard 130 is configured to attach to the mouth-port 118 (FIG. 3). The mouthguard 130 is removably replaceable for easy cleaning and maintenance. The mouthguard 130 includes a breathing-channel 132 (FIG. 3) that allows the passage of breathable air therethrough. At least one filter 140 is configured to attach to the at least one filter-port (not shown). The at least one filter 140 comprises a filter media that is configured to impede the passage of particulates. The filter media is also configured to impede the passage of chemicals. The at least one filter 140 is removably replaceable from the filter-port (not shown). The filter-port (not shown) may comprise an aperture on the body having the standardized geometry to attach at least one filter 140. The filter-port (not shown) is configured to mate with standardized filters.

FIG. 3 is a rear perspective view of the personal breathing apparatus 100 of FIG. 1, according to an embodiment of the present disclosure. The personal breathing apparatus 100 includes a body 110 having an exhaust port 112 (FIG. 2), a nasal-port 114, at least one filter-port (not shown), and a mouth-port 118. The body 110 may be form factored to be as small and as light as possible. The body 110 may comprise a rigid material sufficient for the attachments of the nasal insert 120, the mouthguard 130, and the at least one filter 140, in conjunction with the at least one one-way valve (not shown). The nasal insert 120 is configured to attach to the nasal-port 114. The mouthguard 130 is configured to attach to the mouth-port 118. The mouthguard 130 is removably replaceable from the mouth-port 118. The mouthguard 130 includes a mouthguard-locking 134 apparatus configured to retain said mouthguard 130 in said mouth-port 118. The mouthguard-locking apparatus creates an air-tight seal between the mouthguard 130 and the mouth-port 118. The mouthguard 130 includes a plurality of ridges 136 configured to retain said mouthguard 130 in said user's mouth. The mouthguard 130 includes a breathing-channel 132 that allows the passage of breathable air therethrough. At least one filter 140 is configured to attach to the at least one filter-port (not shown).

FIG. 4 is another view of the personal breathing apparatus 100 of FIG. 1, according to an embodiment of the present disclosure. A nasal insert 120 is configured to attach to the nasal-port 114. The nasal insert 120 includes a nasal-channel 122 configured for the passage of breathable air. In one embodiment, the nasal insert 120 is configured to pinch 201 the nasal cavities of a user's nose closed. In another embodiment, the nasal insert 120 is configured to restrict 202 the passage of breathable air to the users' nasal cavity. The nasal insert 120 is removably replaceable from said nasal-port 114. The nasal insert 120 is configured to create a air tight barrier preventing the passage of breathable air into a user's nasal cavity. The mouthguard 130 is anatomically shaped to create an air-tight seal to a user's mouth. The mouthguard 130 is configured to attach to the mouth-port 118. In a preferred embodiment, the mouthguard 130 comprises rubber (other suitably equivalent materials may be used). The mouthguard 130 includes a breathing-channel 132 (FIG. 3) that allows the passage of breathable air therethrough.

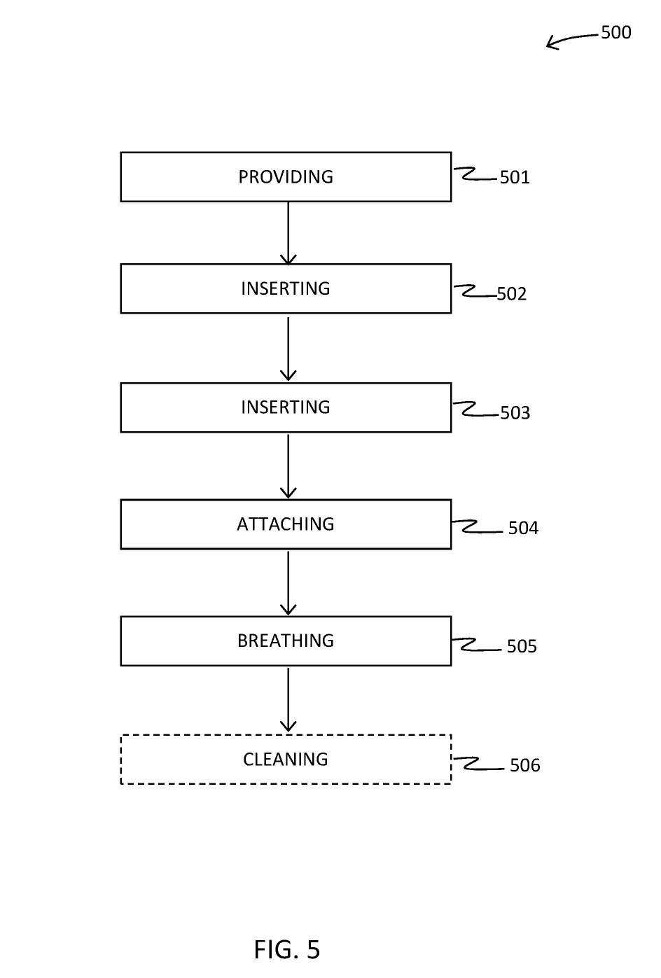

FIG. 5 is a flow diagram illustrating a method for using 500 a personal breathing apparatus 100, according to an embodiment of the present disclosure. In particular, the method for using 500 a personal breathing apparatus 100 may include one or more components or features of the personal breathing apparatus 100 as described above. As illustrated, the method for using 500 a personal breathing apparatus 100 may include the steps of: step one 501, providing a personal breathing apparatus, the personal breathing apparatus comprising a body having an exhaust port, a nasal-port, at least one filter-port (not shown), and a mouth-port; a nasal insert, the nasal insert is configured to attach to said nasal-port; a mouthguard, the mouthguard is anatomically shaped to create an air-tight seal to a user's mouth, the mouthguard is configured to attach to the mouth-port, the mouthguard includes a breathing-channel configured for the passage of breathable air; at least one filter, the at least one filter is configured to attach to said at least one filter-port (not shown); and, at least one one-way valve (not shown); step two 502, inserting mouthguard into to the mouth-port of the body; step three 503, inserting the nasal insert into the nasal-port of said body; step four 504, attaching at least one filter to the at least one filter-port (not shown) of said body; step five 505, breathing through the mouthguard and the nasal insert; step six 506, cleaning the mouthguard, the nasal insert, and the body.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a personal breathing apparatus are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A personal breathing apparatus, the personal breathing apparatus comprising:
a body having an exhaust port, a nasal-port, at least one filter-port, and a mouth-port;
a nasal insert, said nasal insert is configured to attach to said nasal-port;
a mouthguard, said mouthguard is anatomically shaped to create an air-tight seal to a user's mouth, said mouthguard is configured to attach to said mouth-port, said mouthguard includes a breathing-channel configured for the passage of breathable air;
at least one filter, said at least one filter is configured to attach to said at least one filter-port; and,
at least one one-way valve.

2. The personal breathing apparatus of claim 1, wherein said nasal insert includes a nasal-channel configured for the passage of breathable air.

3. The personal breathing apparatus of claim 1, wherein said nasal insert is configured to pinch the nasal cavities of a user's nose closed.

4. The personal breathing apparatus of claim 1, wherein said nasal insert is removably replaceable from said nasal-port.

5. The personal breathing apparatus of claim 1, wherein said nasal insert is configured to create an air tight barrier, preventing the passage of breathable air into a user's nasal cavity.

6. The personal breathing apparatus of claim 1, wherein said mouthguard is removably replaceable from said mouth-port.

7. The personal breathing apparatus of claim 1, wherein said mouthguard comprises rubber.

8. The personal breathing apparatus of claim 1, wherein said mouthguard includes a mouthguard-locking apparatus configured to retain said mouthguard in said mouth-port.

9. The personal breathing apparatus of claim 1, wherein said mouthguard includes a plurality of ridges configured to retain said mouthguard in said user's mouth.

10. The personal breathing apparatus of claim 1, wherein said at least one one-way valve is configured to be removably replaceable from said body.

11. The personal breathing apparatus of claim 1, wherein said at least one filter comprises a filter media that is configured to impede the passage of particulates.

12. The personal breathing apparatus of claim 11, wherein said filter media is configured to impede the passage of chemicals.

13. The personal breathing apparatus of claim 1, wherein said at least one filter is removably replaceable from said filter-port.

14. The personal breathing apparatus of claim 1, wherein said filter-port is configured to mate with standardized filters.

15. The personal breathing apparatus of claim 1, wherein said at least one one-way valve is selected from a group consisting of butterfly valves, flap vales, ball bearing valves, and check valves.

16. The personal breathing apparatus of claim 1, wherein said at least one one-way valve is connected with said exhaust port.

17. A personal breathing apparatus comprising:
a body having an exhaust port, a nasal-port, at least one filter-port, and a mouth-port,
a nasal insert, said nasal insert is configured to attach to said nasal-port,
a mouthguard, said mouthguard is anatomically shaped to create an air-tight seal to a user's mouth, said mouthguard is configured to attach to said mouth-port, said mouthguard includes a breathing-channel configured for the passage of breathable air,
at least one filter, said at least one filter is configured to attach to said at least one filter-port, and
at least one one-way valve;
wherein said nasal insert includes a nasal-channel configured for the passage of breathable air;
wherein said nasal insert is configured to pinch the nasal cavities of a user's nose closed;
wherein said nasal insert is removably replaceable from said nasal-port;
wherein said nasal insert is configured to create an air tight barrier, preventing the passage of breathable air into a user's nasal cavity;
wherein said mouthguard is removably replaceable from said mouth-port;
wherein said mouthguard comprises rubber;
wherein said mouthguard includes a mouthguard-locking apparatus configured to retain said mouthguard in said mouth-port;
wherein said mouthguard includes a plurality of ridges configured to retain said mouthguard in said user's mouth;
wherein said at least one one-way valve is configured to be removably replaceable from said body;
wherein said at least one filter comprises a filter media that is configured to impede the passage of particulates;
wherein said filter media is configured to impede passage of chemicals;
wherein said at least one filter is removably replaceable from said filter-port;
wherein said filter-port is configured to mate with standardized filters;
wherein said at least one one-way valve is selected from a group consisting of butterfly valves, flap vales, ball bearing valves, and check valves; and
wherein said at least one one-way valve is connected with said exhaust port.

18. The personal breathing apparatus of claim 17, further comprising set of instructions; and
wherein the personal breathing apparatus is arranged as a kit.

19. A method of using a personal breathing apparatus, the method comprising the steps of:
providing a personal breathing apparatus;
inserting a mouthguard into to a mouth-port of a body;
inserting a nasal insert into a nasal-port of said body;
attaching at least one filter to at least one filter-port of said body; and
breathing through said mouthguard and said nasal insert.

20. The method of claim 19, further comprising the step of cleaning said mouthguard, said nasal insert, and said body.
